(19) United States
(12) Patent Application Publication
(10) Pub. No.: US 2025/0382514 A1
(43) Pub. Date: Dec. 18, 2025

(54) CURABLE ADHESIVE COMPOSITION COMPRISING MALEIMIDE AND THIOL

(71) Applicant: Henkel AG & Co. KGaA, Duesseldorf (DE)

(72) Inventors: LvYuan Ye, Shanghai (CN); Kily Qili Wu, Shanghai (CN); Serena CuiRui Luo, Shanghai (CN); Morgan WeiWei Xun, Shanghai (CN); Bin Zhao, Shanghai (CN); David Chenyu Huang, Shanghai (CN); Yang Ti, Shanghai (CN)

(21) Appl. No.: 19/287,669

(22) Filed: Jul. 31, 2025

Related U.S. Application Data
(63) Continuation of application No. PCT/CN2021/079290, filed on Mar. 5, 2021.

(51) Int. Cl. C09J 179/08; C08F 122/40; C08K 3/36; C08K 5/3445; C08K 9/06

(52) U.S. Cl. CPC C09J 179/085; C08K 3/36; C08K 5/3445; C08K 9/06; C08F 122/40

(57) ABSTRACT

The present invention relates to a curable adhesive composition comprising (A) at least one maleimide compound, (B) at least one thiol compound having at least two mercapto groups and no siloxane group in the molecule; (C) at least one latent curing agent; and (D) optionally, at least one photo radical polymerization initiator. The cured product derived from the present adhesive composition features high moisture resistant property. Furthermore, the invention also provided an article comprising the cured adhesive composition, and the use thereof.

### TECHNICAL FIELD

The present invention relates to a curable adhesive composition comprising maleimide and thiol, an article comprising the cured adhesive composition, and the use thereof.

### BACKGROUND OF THE INVENTION

To improve the moisture-resistant property for low-temperature cured adhesives is challenging in the electronic applications. The recent image sensor module has been made of various materials such as glass, metal, and liquid crystal polymer (hereinafter referred to as “LCP”). When these modules made of various materials are adherends, the cured product of the adhesive exhibiting high moisture resistance reliability relating to bonding strength has been in demand. It has been known that a thiol-containing composition is promising for realizing recently demanded low-temperature fast curability. For example, acrylates and thiol have been selected as main components to fabricate low-temperature cured adhesives for UV/heat dual cure application. However, the adhesives based on this combination exhibits poor moisture resistance, which is most likely because of the hydrolytic ester structure in the polymer skeleton.

To solve the problem mentioned above, U.S. Pat. No. 15,556,964 discloses a tailor-made chemical structure of thiol having lower amount of ester groups to improve the moisture resistance. However, the synthetic method of the thiol is too complex, and the thiol structure is too restricted for wider application.

Maleimides have attracted much attention for their high modulus and excellent resistance to thermal degradation, which is mainly used to produce adhesive joints, heat-resistant composite materials and high-performance coatings. Many efforts have been made to modify bis-maleimide (BMI) to explore the application, which were disclosed in the patents identified and discussed below.

WO 2009/145779 A1 disclosed diamine or dithiol used to extend BMI to obtain oligomeric compounds with better solubility and greater toughness.

WO 2010/016946 A2 disclosed metal/carboxylate complex and peroxide used to cure maleimide-compound below 100° C.

WO 2018/201428 A1 disclosed a thermally curable sealant composition comprising (a) a thermally curable epoxy resin selected from maleimide resins, maleimide-modified epoxy resins and any combinations thereof; (b) a latent curing agent; (c) a poly-siloxane containing a mercapto group; and optionally a stabilizer.

Consequently, the inventors came up with a novel idea to combine maleimides and thiol compound to develop a low-temperature curable adhesive that its cured product exbibits high moisture-resistant property.

### SUMMARY OF THE INVENTION

After intensive studies, the inventors have found that the above problem can be solved by a curable adhesive composition comprising:
(A) at least one maleimide compound;
(B) at least one thiol compound having at least two mercapto groups and no siloxane group in the molecule;
(C) at least one latent curing agent; and
(D) optionally, at least one photo radical polymerization initiator.

In another aspect of the present invention, provided is an article comprising a first substrate, a cured adhesive, and a second substrate bonded to the first substrate through the cured adhesive derived from the curable adhesive composition according to the present invention.

In an additional aspect of the invention, provided is an electronic device comprising the article of the present invention or produced using the curable adhesive composition according to the present invention.

In yet another aspect of the invention, the use of the curable adhesive composition and the article according to the present invention in manufacturing electronic devices is provided.

### DETAILED DESCRIPTION OF THE INVENTION

It is to be understood by one of ordinary skill in the art that the present invention is a description of exemplary embodiments only and is not intended as limiting the broader aspects of the present invention. Each aspect so described may be combined with any other aspect or aspects unless clearly indicated to the contrary. In particular, any feature indicated as being preferred or advantageous may be combined with any other feature or features indicated as being preferred or advantageous.

Unless specified otherwise, in the context of the present invention, the terms used are to be construed in accordance with the following definitions.

Unless specified otherwise, as used herein, the terms “a”, “an” and “the” include both singular and plural referents.

The terms “comprising” and “comprises” as used herein are synonymous with “including”, “includes” or “containing”, “contains”, and are inclusive or open-ended and do not exclude additional, non-recited members, elements, or process steps.

Unless specified otherwise, the recitation of numerical end points includes all numbers and fractions subsumed within the respective ranges, as well as the recited end points.

All references cited in the present specification are hereby incorporated by reference in their entirety.

Unless otherwise defined, all terms used in the present invention, including technical and scientific terms, have the meaning as commonly understood by one of the ordinary skilled in the art to which this invention belongs.

The present invention is directed to a curable adhesive composition comprising:
(A) at least one maleimide compound;
(B) at least one thiol compound having at least two mercapto groups and no siloxane group in the molecule;
(C) at least one latent curing agent; and
(D) optionally, at least one photo radical polymerization initiator.

### Maleimide Compound

According to the present invention, one notable feature is that the maleimide compound is contained in the curable adhesive composition.

The maleimide compound suitable for use in the present invention has the generic formula structure (I):

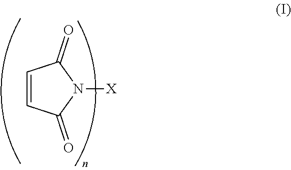

wherein n is an integer no less than 2, X is an aromatic group or aliphatic group.

In preferred embodiments, the adhesive composition comprises bis-, tris-, or tetramaleimide compound, and more preferably bismaleimide (BMI) compound.

BMI compounds suitable for use in the present invention have the formula structure (II):

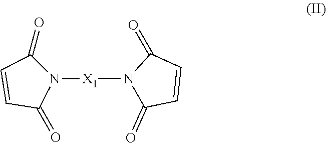

wherein X₁ is a divalent hydrocarbyl linker.

Exemplary divalent hydrocarbyl linker can be selected from linear or branched alkylenes, cycloalkylenes, bicycloalkylenes, tricycloalkylenes, alkenylenes, arylenes, aralkylenes, arylbicycloalkylenes, aryltricycloalkylenes, cycloalkenylene, cycloalkylarylenes, biphenylenes, heterocycloalkylene or heterocycloarylenes having from 1 to 36 carbon atoms, and optionally contain at least one carbonyl group, carboxyl group, amide group, carbamate group, urea group, ester group, ether group, and combinations thereof.

“Alkylene” described herein refers to any divalent radical derived from an aliphatic saturated hydrocarbon by the removal of two hydrogen atoms. Higher alkylene radicals of from 12 to 36 carbon atoms are preferred in the present invention.

“Cycloalkylene” described herein refers to any divalent radical derived by removal of two hydrogen atoms from cycloalkane.

“Bicycloalkylene” described herein refers to any divalent radical derived by removal of two hydrogen atoms from cycloalkane whose molecule contains two rings.

“Tricycloalkylene” described herein refers to any divalent radical derived by removal of two hydrogen atoms from cycloalkane whose molecule contains three rings.

“Alkenylene” described herein refers to any divalent radical derived by removal of two hydrogen atoms from different carbon atoms of an alkene.

“Arylene” described herein refers to any divalent radical derived from a polyunsaturated, aromatic single ring or multiple rings (preferably from 1 to 3 rings) which are fused together or linked covalently by the removal of two hydrogen atoms.

“Aralkylene” described herein refers to any divalent radical derived from an aryl group attached to the alkylene defined above.

“Arylbicycloalkylene” described herein refers to any divalent radical derived from by removal of two hydrogen atoms from cycloalkane whose molecule contains two rings and an aryl group.

“Aryltricycloalkylene” described herein refers to any divalent radical derived from by removal of two hydrogen atoms from cycloalkane whose molecule contains three rings and an aryl group.

“Cycloalkenylene” described herein refers to any divalent radical derived by removal of two hydrogen atoms from different carbon atoms of a cycloalkene.

“Cycloalkylarylenes” described herein refers to any divalent radical derived from by removal of two hydrogen atoms from the aryl group comprised in a fused cycloalkylaryl containing both saturated ring and benzene rings.

“Biphenylene” described herein refers to any divalent radical derived from by removal of two hydrogen atoms from polycyclic hydrocarbon composed of two benzene rings joined together by a pair of mutual attachments.

“Heterocycloalkylene” described herein refers to any divalent radical derived from by removal of two hydrogen atoms from a non-aromatic monocyclic or polycyclic ring comprising carbon and hydrogen atoms and at least one heteroatom, preferably, 1 to 4 heteroatoms selected from nitrogen, oxygen, and sulfur.

“Heterocycloarylene” described herein refers to any divalent radical derived from by removal of two hydrogen atoms from an aromatic group containing polycyclic ring comprising carbon and hydrogen atoms and at least one heteroatom, preferably, 1 to 4 heteroatoms selected from nitrogen, oxygen, and sulfur.

Preferred BMI compounds used in the present invention include but not limited to the following formulae structure (A1) to (A4):

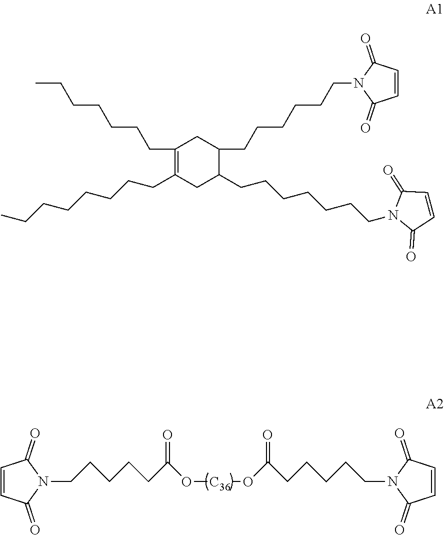

wherein C₃₆ represents a linear or branched chain (with or without cyclic moieties) of 36 carbon atoms.

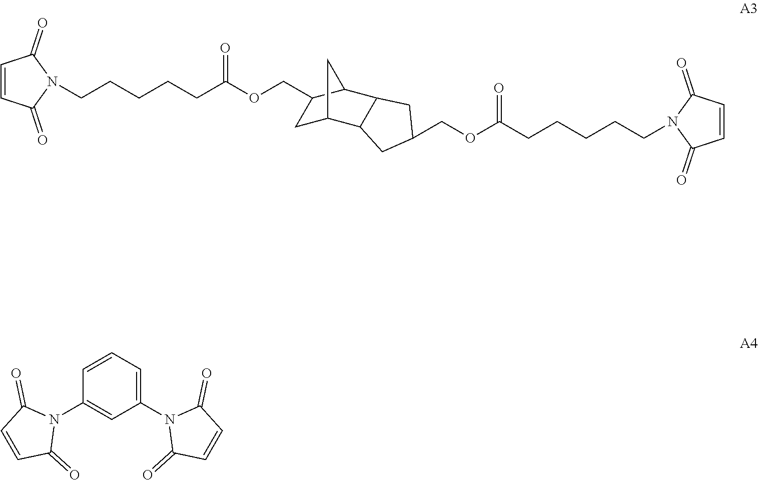 [SMILES: O=C(CCCCCN1C(=O)C=CC1=O)OCC1CC2C3CC(COC(=O)CCCCCN4C(=O)C=CC4=O)C(C3)C2C1 ; O=C1C=CC(=O)N1c1cccc(N2C(=O)C=CC2=O)c1]

Exemplary BMI compounds used in the present invention can be prepared by reaction of maleic anhydride with dimer amines (i.e., α, ω-diamino hydrocarbons prepared from dimer acids, a mixture of mono-, di- and tri-functional oligomeric, aliphatic carboxylic acids; dimer acids are typically prepared by thermal reaction of unsaturated fatty acids, such as oleic acid, linoleic acid, and the like, which induces ene/Diels-Alder reactions leading to the above-mentioned mixture of components).

An exemplary BMI compound used in the present invention which can be prepared from dimer amines such as 1,20-bismaleimido-10, 11-dioctyl-eicosane, which would likely exist in admixture with other isomeric species produced in the ene/Diels-Alder reactions employed to produce dimer acids. Other BMI compounds contemplated for use in the present invention include BMIs prepared from α, ω-aminopropylterminated polydimethyl siloxanes (such as “PS510” sold by Huls), polyoxypropylene amines (such as “D-230”, “D-400”, “D-2000” and “T-403”, sold by Huntsman), polytetramethyleneoxide-di-p-aminobenzoates (such as “Versalink P-650” sold by Air Products), and the like.

The BMI compounds used in the present invention are commercially available and can be obtained, for example, CM1016 from Henkel, SR525 from Sartomer and BMI4 from Henkel.

In other embodiments, maleimide compounds suitable for use in the present invention include those having the generic structure (I) in which n is an integer greater than 2 and X is an aliphatic or aromatic group. Exemplary X entitles include, but not limited to, poly(butadienes), poly(carbonates), poly(urethanes), poly(ethers), poly(esters), simple hydrocarbons, and simple hydrocarbons containing functionalities such as carbonyl, carboxyl, amide, carbamate, urea, or ether. Specific preferred maleimide compounds include the following formula structure (A5):

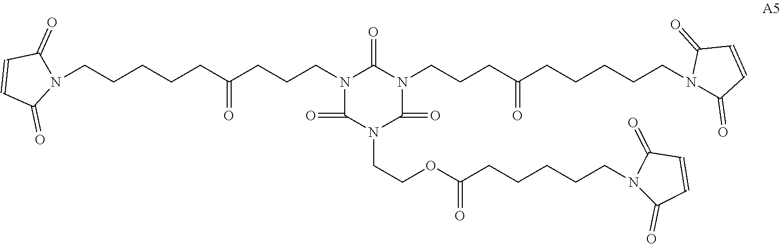 [SMILES: O=C(CCCCCN1C(=O)C=CC1=O)CCCn1c(=O)n(CCCC(=O)CCCCCN2C(=O)C=CC2=O)c(=O)n(CCOC(=O)CCCCCN2C(=O)C=CC2=O)c1=O]

The maleimide compounds used in the present invention are commercially available and can be obtained, for example, TrisMI-1 from Henkel.

These above described maleimide compounds can be used alone or in combination. However, the maleimide compound can be used in the present invention is not limited to these examples.

With particular preference, the component (A) incorporated in the curable adhesive composition is present in an amount of from 10 to 80% by weight, preferably from 20 to 70% by weight, based on the total weight of the composition.

### Thiol Compound

According to the present invention, the composition comprises at least one thiol compound having at least two mercapto groups and no siloxane group in the molecule. The thiol compound without —Si—O—Si— linkage in the compound can better disperse with maleimide compounds to form the adhesive composition than those having polysiloxane thiols.

The term “siloxane group”, as used herein, is a substituted organosilicon compound which is composed of —Si—O—Si— backbones with side chains R attached to the silicon atoms, where each R is independently a hydrogen atom or an organic radical possibly bearing functional groups.

In preferred embodiments, the curable adhesive composition comprises at least one thiol compound having at least two mercapto groups, preferably three mercapto groups, more preferably four mercapto groups and no siloxane group in the molecule.

In some embodiments, the composition comprises at least one thiol compound having at least two mercapto groups and no siloxane group in the molecule, wherein the at least two mercapto groups can bond to a divalent linking unit selected from C₁-C₃₆ aliphatic groups, C₄-C₃₆ alicyclic groups, C₆-C₄₀ aromatic groups, urethane groups, imide groups, carbonyl groups, carboxyl groups, amide groups, carbamate groups, urea groups, ester groups, ether groups, poly(butadiene) groups, polycarbonate groups, polyurethane groups, polyether groups, polyester groups and combinations thereof.

“Aliphatic group” described herein refers to an optionally substituted linear or branched C₁₋₃₆ hydrocarbon, which is completely saturated, or which contains one or more units of unsaturation, but which is not aromatic. For example, suitable aliphatic groups include optionally substituted linear or branched alkyl, alkenyl, alkynyl groups and hybrids thereof.

“Alkyl” described herein, used alone or as part of a larger moiety, refers to an optionally substituted linear or branched hydrocarbon group having 1 to 36 carbon atoms.

“Alkenyl” described herein, used alone or as part of a larger moiety, refers to an optionally substituted linear or branched hydrocarbon group having at least one carbon-carbon double bond and having 2 to 36 carbon atoms.

“Alkynyl”, described herein, used alone or as part of a larger moiety, refers to an optionally substituted linear or branched hydrocarbon group having at least one carbon-carbon triple bond and having 2 to 36 carbon atoms.

It will be appreciated that the phrase “optionally substituted” is used interchangeably with the phrase “substituted or unsubstituted.” In general, the term “substituted”, whether preceded by the term “optionally” or not, means that a hydrogen radical of the designated moiety is replaced with the radical of a specified substituent, provided that the substitution results in a stable or chemically feasible compound. Unless otherwise indicated, an “optionally substituted” group may have a substituent at each substitutable position of the group, and when more than one position in any given structure may be substituted with more than one substituent selected from a specified group, the substituent may be either the same or different at every position. Combinations of substituents envisioned by this disclosure are for instance, those that result in the formation of stable or chemically feasible compounds.

“Alicyclic”, described herein refers to a group which combines the properties of aliphatic and cyclic compounds and include but are not limited to monocyclic, or polycyclic aliphatic hydrocarbons and bridged cycloalkyl groups, which are optionally substituted with one or more functional groups. As will be appreciated by one of ordinary skill in the art, “alicyclic” is intended herein to include, but is not limited to, C₄-C₃₆, preferably C₄-C₃₀ cycloalkyl, cycloalkenyl, and cycloalkynyl moieties, which are optionally substituted with one or more functional groups.

“Cycloalkyl” used in component (B) refers specifically to groups having 4 to 36, preferably 4 to 30 carbon atoms. Suitable cycloalkyls include, but are not limited to cyclobutyl, cyclopentyl, cyclohexyl, cycloheptyl and the like.

“Aromatic group” used in component (B) refers to a stable mono- or polycyclic, unsaturated moiety having preferably 6 to 40 carbon atoms, preferably 6 to 30 carbon atoms, each of which may be substituted or unsubstituted. In certain embodiments, the term “aromatic moiety” refers to a planar ring having p-orbitals perpendicular to the plane of the ring at each ring atom and satisfying the Huckel rule where the number of pi electrons in the ring is (4n+2) wherein n is an integer. A mono- or polycyclic, unsaturated moiety that does not satisfy one or all of these criteria for aromaticity is defined herein as “non-aromatic” and is encompassed by the term “alicyclic”.

Preferably, the thiol compounds may have ester groups, s-triazinetrione groups, pentaerythritol groups, or bicyclic heteroaryl groups such as imidazoimidazole derived groups, and have two to four mercapto groups in one molecule.

Examples of the thiol compound used in the present invention include but not limited to, methanedithiol, 1,2-ethanedithiol, 1,2-propanedithiol, 1,3-propanedithiol, 1,4-butanedithiol, 1,5-pentanedithiol, 1,6-hexanedithiol, 1,2-cyclohexanedithiol, 3,4-dimethoxybutane-1,2-dithiol, 2-methylcyclohexane-2,3-dithiol, 1,2-dimercaptopropyl methyl ether, 2,3-dimercaptopropyl methyl ether, bis(2-mercaptoethyl)ether, tetrakis(mercaptomethyl)methane, bis(mercaptomethyl)sulfide, bis(mercaptomethyl)disulfide, bis(mercaptoethyl)sulfide, bis(mercaptoethyl)disulfide, bis(mercaptomethylthio)methane, bis(2-mercaptoethylthio)methane, 1,2-bis(mercaptomethylthio)ethane, 1,2-bis(2-mercaptoethylthio)ethane, 1,3-bis(mercaptomethylthio)propane, 1,3-bis(2-mercaptoethylthio)propane, 1,2,3-tris(mercaptomethylthio)propane, 1,2,3-tris (2-mercaptoethylthio)propane, 1,2,3-tris(3-mercaptopropylthio)propane, 4-mercaptomethyl-1, 8-dimercapto-3,6-dithiaoctane, 5,7-dimercaptomethyl-1,11-dimercapto-3,6,9-trithiaundecane, 4,7-dimercaptomethyl-1, II-dimercapto-3,6,9-trithiaundecane, 4,8-dimercaptomethyl-I,II-dimercapto-3,6,9-trithiaundecane, 1,1,3,3-tetrakis(mercaptomethylthio)propane, 4,6-bis(mercaptomethylthio)-1,3-dithiane, 2-(2,2-bis(mercaptomethylthio)ethyl)-1, 3-dithietane, tetrakis(mercaptomethylthiomethyl)methane, tetrakis(2-mercaptoethylthiomethyl)methane, bis(2,3-dimercaptopropyl)sulfide, 2,5-bismercaptomethyl-1,4-dithiane, ethylene glycol bis(2-mercaptoacetate), ethylene glycol bis(3-mercaptopropionate), diethylene glycol bis(2-mercaptoacetate), diethylene glycol bis(3-mercaptopropionate), 2,3-dimercapto-1-propanol (3-mercaptopropionate), 3-mercapto-1,2-propanediol bis(2-mercaptoacetate), 3-mercapto-1,2-propanediol di(3-mercaptopropionate), trimethylolpropane tris(2-mercaptoacetate), ditrimethylolpropane tetrakis(2-mercaptoacetate), trimethylolpropane tris(3-mercaptopropionate), ditrimethylolpropane tetrakis(3-mercaptopropionate), trimethylol ethane tris(2-mercaptoacetate), trimethylol ethane tris(3-mercaptopropionate), pentaerythritol tetrakis(2-mercaptoacetate), dipentaerythritol hexa(2-mercaptoacetate), pentaerythritol di(3-mercaptopropionate), pentaerythritol tris(3-mercaptopropionate), pentaerythritol tetrakis(3-mercaptopropionate), dipentaerythritol hexa(3-mercaptopropionate), glycerin di(2-mercaptoacetate), glycerin tris(2-mercaptoacetate), glycerin di(3-mercaptopropionate), glycerin tris(3-mercaptopropionate), 1,4-cyclohexane diol bis(2-mercaptoacetate), 1,4-cyclohexane diol bis(3-mercaptopropionate), hydroxymethyl sulfide bis(2-mercaptoacetate), hydroxymethyl sulfide bis(3-mercaptopropionate), hydroxyethyl sulfide (2-mercaptoacetate), hydroxyethyl sulfide (3-mercaptopropionate), hydroxymethyl disulfide (2-mercaptoacetate), hydroxymethyl disulfide (3-mercaptopropionate), thioglycolic acid bis(2-mercapto ethyl ester), thiodipropionic acid bis(2-mercapto ethyl ester), N,N′,N″-tris(3-mercaptopropylcarbonyloxyethyl)isocyanurate, 1,2-dimercaptobenzene, 1,3-dimercaptobenzene, 1,4-dimercaptobenzene, 1,2-bis(mercaptomethyl)benzene, 1,4-bis(mercaptomethyl)benzene, 1,2-bis(mercaptoethyl)benzene, 1,4-bis(mercaptoethyl)benzene, 1,2,3-trimercaptobenzene, 1,2,4-trimercaptobenzene, 1,3,5-trimercaptobenzene, 1,2,3-tris(mercaptomethyl)benzene, 1,2,4-tris(mercaptomethyl)benzene, 1,3,5-tris(mercaptomethyl)benzene, 1,2,3-tris(mercaptoethyl)benzene, 1,3,5-tris(mercaptoethyl)benzene, 1,2,4-tris(mercaptoethyl)benzene, 2,5-toluenedithiol, 3,4-toluenedithiol, 1,4-naphthalene dithiol, 1,5-naphthalene dithiol, 2,6-naphthalene dithiol, 2,7-naphthalene dithiol, 1,2,3,4-tetramercaptobenzene, 1,2,3,5-tetramercaptobenzene, 1,2,4,5-tetramercaptobenzene, 1,2,3,4-tetrakis(mercaptomethyl)benzene, 1,2,3,5-tetrakis(mercaptomethyl)benzene, 1,2,4,5-tetrakis(mercaptomethyl)benzene, 1,2,3,4-tetrakis(mercaptoethyl)benzene, 1,2,3,5-tetrakis(mercaptoethyl)benzene, 1,2,4,5-tetrakis(mercaptoethyl)benzene, 2,2′-dimercaptobiphenyl, 4,4′-dimercaptobiphenyl, and the like.

Specific examples of the thiol compound used in the present invention include, but not limited to, formulae structural B1 to B19 represented as below:

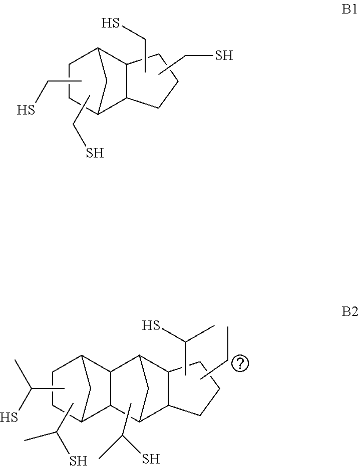

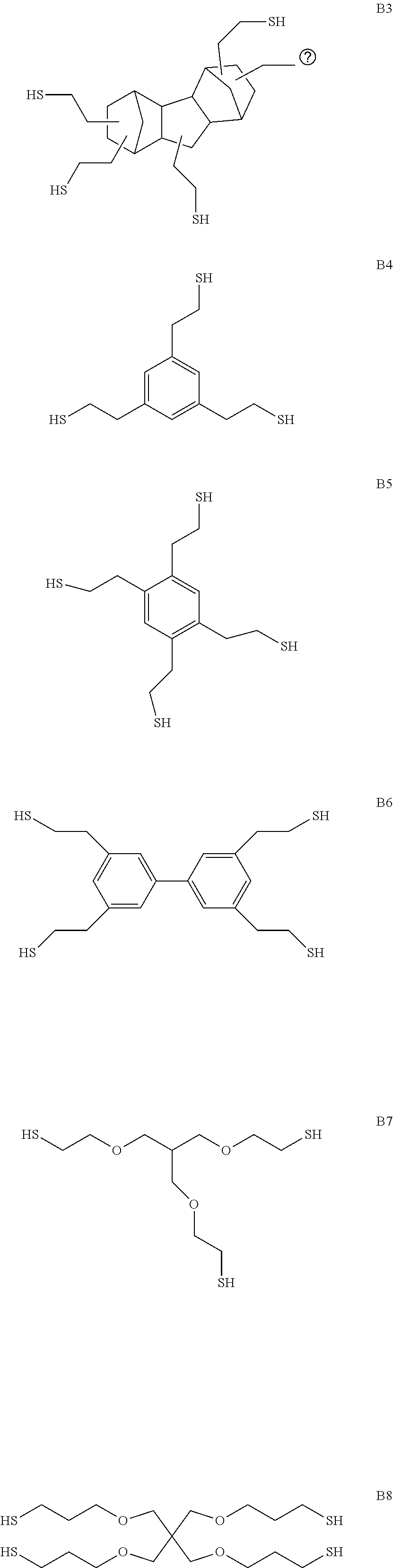

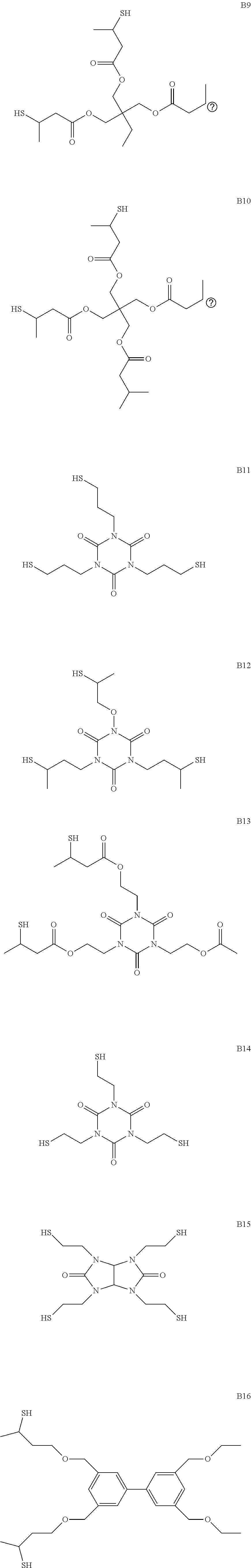

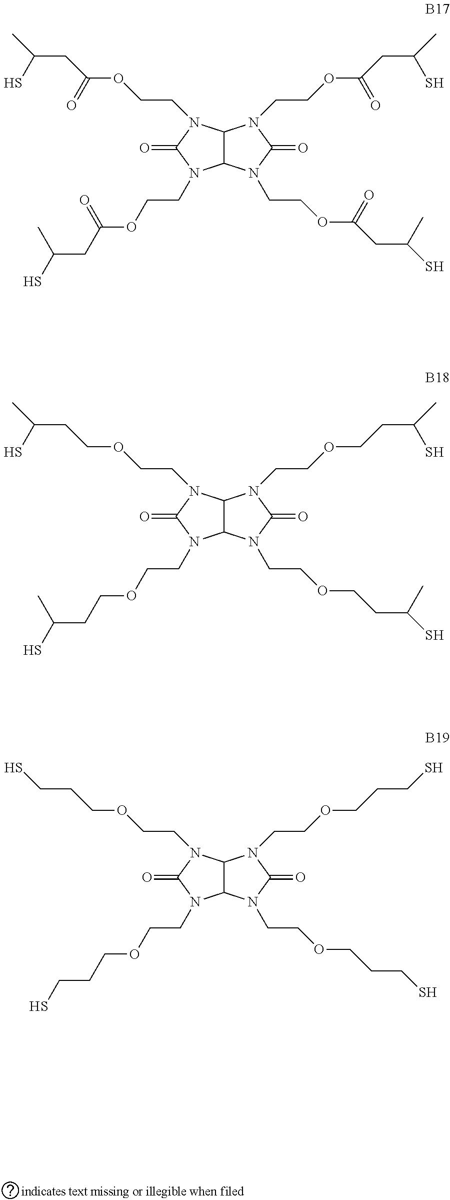

In preferred embodiments, the component (B) can be thiol compound having at least two mercapto groups in the molecule bonded to a divalent linking unit, wherein the divalent linking unit is C₁₂-C₃₆ aliphatic groups and containing one or more ether groups. The thiol compound having such substantially flexible skeleton generates an increasing bonding strength to the cured adhesive after hydrothermal aging.

Such examples include but not limited to 3,3′-[[2,2-bis[(3-mercaptopropoxy)methyl]propane-1,3-diyl]dioxy]bis(propane-1-thiol), 1-[3-(2-sulfanylpropoxy)-2,2-bis(2-sulfanylpropoxymethyl)propoxy]propane-2-thiol, 3-[2-(methoxymethyl)-3-(3-sulfanylpropoxy)-2-(3-sulfanylpropoxymethyl)propoxy]propane-1-thiol, 2-(sulfanylmethyl)-2-[[3-sulfanyl-2-[[3-sulfanyl-2,2-bis(sulfanylmethyl)propoxy]methyl]-2-(sulfanylmethyl)propoxy]methyl]propane-1,3-dithiol, 2-[3-(2-sulfanylethoxy)-2,2-bis(2-sulfanylethoxymethyl)propoxy]ethanethiol, 2-[2-[3-[2-(2-sulfanylethoxy)ethoxy]-2,2-bis[2-(2-sulfanylethoxy)ethoxymethyl]propoxy]ethoxy]ethanethiol, 3-[2-(butoxymethyl)-3-(3-sulfanylpropoxy)-2-(3-sulfanylpropoxymethyl)propoxy]propane-1-thiol, 3-[2-[2-(2-sulfanylethoxy)ethoxymethyl]-2-(2-sulfanylethylperoxymethyl)-3-(3-sulfanylpropoxy)propoxy]propane-1-thiol, 3-[2-(2-sulfanylethylperoxymethyl)-3-(3-sulfanylpropoxy)-2-(3-sulfanylpropoxymethyl)propoxy]propane-1-thiol, 3-[3-(3-sulfanylpropoxy)-2-[[3-(3-sulfanylpropoxy)-2,2-bis(3-sulfanylpropoxymethyl)propoxy]methyl]-2-(3-sulfanylpropoxymethyl)propoxy]propane-1-thiol, 2-[3-(2-sulfanylethoxy)-2-[[3-(2-sulfanylethoxy)-2,2-bis(2-sulfanylethoxymethyl)propoxy]methyl]-2-(2-sulfanylethoxymethyl)propoxy]ethanethiol, 3-[2,2-bis[2-(2-sulfanylethoxy)ethoxymethyl]-3-(2-sulfanylethylperoxy)propoxy]propane-1-thiol, 3-[2-[3-[2-(3-sulfanylpropoxy)ethoxy]-2,2-bis[2-(3-sulfanylpropoxy)ethoxymethyl]propoxy]ethoxy]propane-1-thiol, O-[3-(3-sulfanylpropanethioyloxy)-2-[[3-(3-sulfanylpropanethioyloxy)-2,2-bis(3-sulfanylpropanethioyloxymethyl)propoxy]methyl]-2-(3-sulfanylpropanethioyloxymethyl)propyl]3-sulfanylpropanethioate and the like.

In other preferred embodiments, the component (B) used in the present invention can be thiol compound having at least two mercapto groups in the molecule bonded to a divalent linking unit, wherein the divalent linking unit is C₄-C₃₆ alicyclic groups or C₆-C₄₀ aromatic groups, selected from arylbicycloalkylenes, aryltricycloalkylenes, cycloalkenylene, cycloalkylarylenes, biphenylenes, heterocycloalkylene, heterocycloarylenes and combinations thereof. The thiol compound having such rigid ring(s) generates an increasing bonding strength to the cured adhesive after hydrothermal tests.

Such examples include but not limited to 1,3,4,6-tetra(2-mercaptoethyl)octahydroimidazo[4,5-d]imidazole-2,5-dione, 1,3,4,6-tetrakis(3-sulfanylpropyl)-3a,6a-dihydroimidazo[4,5-d]imidazole-2,5-dione, 3a-methyl-1,3,4,6-tetrakis(2-sulfanylethyl)-6aH-imidazo[4,5-d]imidazole-2,5-dione, 1,3,4,6-tetrakis(2-methylsulfanylethyl)-3a,6a-dihydroimidazo[4,5-d]imidazole-2,5-dione, 1,6-dipropyl-3,4-bis(2-sulfanylethyl)-3a,6a-dihydroimidazo[4,5-d]imidazole-2,5-dione, 6-propyl-1,3,4-tris(2-sulfanylethyl)-3a,6a-dihydro-2H-imidazo[4,5-d]imidazol-5-one, and the like.

These above-described thiol compound can be used alone or in combination. However, the above-described thiol compound having at least two mercapto groups and no siloxane group in the molecule is not limited to these examples.

The above-mentioned thiol compound can be prepared by employing techniques well known to those of skill in the art or commercially available.

Commercial examples of thiol compound are Karenz^{MT} BD1, Karenz^{MT} NR1 available from Showa Denko K. K., Multhiol Y4 available from SC Organic Chemical Co., and C3TS-G, available from Shikoku.

In preferred embodiments, the ratio of maleimide equivalents in the component (A) to the mercapto equivalents in component (B) is from 0.2 to 1.8, preferable from 1.0 to 1.5.

With particular preference, the component (B) may be incorporated into the curable adhesive composition in an amount of from 15% to 70% by weight, preferably from 15% to 40% by weight, based on the total weight of the composition.

### Latent Curing Agent

According to the present invention, the curable adhesive composition comprises at least one latent curing agent.

The latent curing agent as the component (C) is a compound which is in an inactive state at room temperature and is activated by heating to act as a curing accelerator.

Examples of latent curing agent may include an imidazole compound, amine adducts obtained by the reaction products of an amine compound with an epoxy compound, an isocyanate compound and/or a urea compound, core-shell type latent curing agent and master batch type latent curing agent.

Examples of the imidazole compound include, but not limited to, 2-heptadecylimidazole, 2-phenyl-4,5-dihydroxymethylimidazole, 2-undecylimidazole, 2-phenyl-4-methyl-5-hydroxymethylimidazole, 2-phenyl-4-benzyl-5-hydroxymethylimidazole, 2,4-diamino-6-(2-methyl imidazolyl-(1))-ethyl-S-triazine, 2,4-diamino-6-(2′-methyl imidazolyl-(1)′)-ethyl-s-triazineisocyanuric acid adducts, 2-methylimidazole, 2-phenylimidazole, 2-phenyl-4-methylimidazole, 1-cyanoethyl-2-phenylimidazole, 1-cyanoethyl-2-methylimidazoletrimellitate, 1-cyanoethyl-2-phenylimidazole-trimellitate, N-(2-methylimidazolyl-1-ethyl)-urea, and N,N′-(2-methylimidazolyl-(1)-ethyl)-adipoyl diamide. However, the imidazole compound which is solid at normal temperature using as latent curing agent in the present invention is not limited to these examples.

Commercial examples of the above-described imidazole compound used as latent curing agent in the present invention include IMICURE® EMI-24 Curing Agent available from Evonik.

Examples of an epoxy compound used as one of raw materials for manufacturing the amine adduct latent curing agent (amine-epoxy-adduct based type latent curing agent) may include polyglycidyl ether obtained by the reaction between polyhydric phenol such as bisphenol A, bisphenol F, catechol, and resorcinol, or polyhydric alcohol such as glycerin and polyethylene glycol, and epichlorohydrin, glycidyl ether ester obtained by the reaction between hydroxycarboxylic acid such as p-hydroxybenzoic acid and 3-hydroxynaphthoic acid, and epichlorohydrin, polyglycidyl ester obtained by the reaction between polycarboxylic acid such as phthalic acid and terephthalic acid, and epichlorohydrin, and a glycidyl amine compound obtained by the reaction between 4,4′-diaminodiphenylmethane, m-aminophenol, or the like, and epichlorohydrin. Further examples may include a multifunctional epoxy compound such as an epoxidized phenol novolac resin, an epoxidized cresol novolac resin, and epoxidized polyolefin, and a monofunctional epoxy compound such as butyl glycidyl ether, phenyl glycidyl ether, and glycidyl methacrylate. However, the above-described epoxy compound using as latent curing agent in the present invention is not limited to these examples.

An amine compound used as another raw material for manufacturing the amine adduct latent curing agent may be any compound which has in its molecule one or more active hydrogens which can undergo an addition reaction with an epoxy group and has in its molecule one or more functional groups selected from a primary amino group, a secondary amino group, and a tertiary amino group. Examples of such an amine compound will be indicated below. Examples thereof may include aliphatic amines such as diethylenetriamine, triethylenetetramine, n-propylamine, 2-hydroxyethyl aminopropylamine, cyclohexylamine, and 4,4′-diamino-dicyclohexylmethane, an aromatic amine compound such as 4,4′-diaminodiphenylmethane and 2-methylaniline, and a nitrogen atom-containing heterocyclic compound such as 2-ethyl-4-methylimidazole, 2-ethyl-4-methylimidazoline, 2,4-dimethylimidazoline, piperidine, and piperazine. However, the above-described amine compound using as latent curing agent in the present invention is not limited to these examples.

Among these, the compound having in its molecule a tertiary amino group is particularly a raw material which provides a latent curing agent having excellent curing promoting properties. Examples of such a compound may include primary or secondary amines having in its molecule a tertiary amino group, such as an amine compound such as dimethylaminopropylamine, diethylaminopropylamine, di-propylaminopropylamine, dibutylaminopropylamine, dimethylaminoethylamine, diethylaminoethylamine, and N-methylpiperazine, and an imidazole compound such as 2-methylimidazole, 2-ethylimidazole, 2-ethyl-4-methylimidazole, and 2-phenylimidazole. Further examples may include alcohols, phenols, thiols, carboxylic acids, hydrazides, and the like, which have in its molecule a tertiary amino group, such as 2-dimethylaminoethanol, 1-methyl-2-dimethylaminoethanol, 1-phenoxymethyl-2-dimethylaminoethanol, 2-diethylaminoethanol, 1-butoxymethyl-2-dimethylaminoethanol, 1-(2-hydroxy-3-phenoxypropyl)-2-methylimidazole, 1-(2-hydroxy-3-phenoxypropyl)-2-ethyl4-methylimidazole, 1-(2-hydroxy-3-butoxypropyl)-2-methylimidazole, 1-(2-hydroxy-3-butoxypropyl)-2-ethyl-4-methylimidazole, 1-(2-hydroxy-3-phenoxypropyl)-2-phenylimidazoline, 1-(2-hydroxy-3-butoxypropyl)-2-methylimidazoline, 2-(dimethylaminomethyl) phenol, 2,4,6-tris(dimethylaminomethyl) phenol, N-nhydroxyethylmorpholine, 2-dimethylaminoethanethiol, 2-mercaptopyridine, 2-benzoimidazole, 2-mercaptobenzoimidazole, 2-mercaptobenzothiazole, 4-mercaptopyridine, N,N-dimethylaminobenzoic acid, N,N-dimethylglycine, nicotinic acid, isonicotinic acid, picolinic acid, N,N-dimethylglycine hydrazide, N,N-dimethylpropionic acid hydrazide, nicotinic acid hydrazide, and isonicotinic acid hydrazide. However, the above-described compound having in its molecule a tertiary amino group using as latent curing agent in the present invention is not limited to these examples.

Examples of an isocyanate compound used as further another raw material of the amine adduct latent curing agent include, but not limited to, a monofunctional isocyanate compound such as n-butyl isocyanate, isopropyl isocyanate, phenyl isocyanate, and benzyl isocyanate, and a multifunctional isocyanate compound such as hexamethylene diisocyanate, toluene diisocyanate, 1,5-naphthalene diisocyanate, diphenylmethane-4,4′-diisocyanate, isophorone diisocyanate, xylyl ene diisocyanate, paraphenylene diisocyanate, 1,3, 6-hexamethylene triisocyanate, and bicycloheptane triisocyanate. Furthermore, there can be used a compound containing at its terminal an isocyanate group, which is obtained by the reaction between these multifunctional isocyanate compounds and an active hydrogen compound. Examples of such a compound containing at its terminal an isocyanate group may include an adduct compound having at its terminal an isocyanate group, which is obtained by the reaction between toluene diisocyanate and trimethylolpropane, and an adduct compound having at its terminal an isocyanate group, which is obtained by the reaction between toluene diisocyanate and pentaerythritol. However, the above-described compound containing at its terminal an isocyanate group using as amine adduct latent curing agent in the present invention is not limited to these examples.

Example of a urea compound used as a raw material for producing amine adduct latent curing agent include, but not limited to, urea, urea phosphate, urea oxalate, urea acetate, diacetyl urea, dibenzoylurea, and trimethylurea.

Commercial examples of the above-described amine adduct latent curing agent include Ajicure PN-23 available from Ajinomoto FineTechno Co., Inc., Ajicure PN-40 available from Ajinomoto Fine-Techno Co., Inc., Ajicure PN-50 available from Ajinomoto FineTechno Co., Inc., Hardener X-3661 S available from A.C.R. Co., Ltd, Hardener X-3670S available from A.C.R. Co., Ltd, and FXR1 121 available from T&K Toka Corporation, Fujicure FXE-1000 available from T&K Toka Corporation and Fujicure FXR-1030 available from T&K Toka Corporation.

Further, the core-shell type latent curing agent is obtained by further treating the surface of an amine compound (or amine adducts) with acid compounds such as a carboxylic acid compound and a sulfonic acid compound, isocyanate compounds or epoxy compounds to form a shell of a modified product (adducts, etc.) onto the surface. Further, the master batch type latent curing agent is the core-shell type latent curing agent in a state of being mixed with an epoxy resin.

Commercially examples of the above-described master batch type curing agents include Novacure HX-3722 available from Asahi Kasei Epoxy Co., Ltd., Novacure HX-3742 available from Asahi Kasei Epoxy Co., Ltd., Novacure HX-3613 available from Asahi Kasei Epoxy Co., Ltd., and the like.

The latent curing agent can be used alone. Alternatively, two or more types of the components may be used in combinations.

With particular preference, the component (C) may be incorporated into the curable adhesive composition in an amount of from 5% to 20% by weight, preferably from 5% to 15% by weight, based on the total weight of the composition.

### Photo Radical Polymerization Initiator

According to the present invention, the curable adhesive composition optionally comprises at least one photo radical polymerization initiator; if present, the curing process may then be initiated by UV radiation.

In some embodiments, both photo initiation and thermal initiation may be desirable. For example, the curing process can be started by UV irradiation, typically via free-radical reaction, and in a later processing step, curing can be completed by the application of heat to accomplish further curing, typically via a thiol-Michael addition reaction. Both UV and thermal initiators may therefore be added to the curable adhesive composition.

In preferred embodiments, the curable adhesive composition does not comprise photo radical polymerization initiator and can only be thermally cured.

There is no special limitation for the photo radical polymerization initiator used in the present invention, as long as it is capable of promoting free radical polymerization, crosslinking, or both. The photo radical polymerization initiator and the amount thereof is preferably selected to achieve a uniform reaction conversion, as a function of the thickness of the composition being cured, as well as a sufficiently high degree of total conversion so as to achieve the desired initial handling strength.

Useful photo radical polymerization initiators include, but not limited to, “alpha cleavage type” photo radical polymerization initiators including, e.g., benzyl dimethyl ketal, benzoin ethers, hydroxy alkyl phenyl ketones, benzoyl cyclohexanol, dialkoxy acetophenones, 1-hydroxycyclohexyl phenyl ketone, trimethylbenzoyl phosphine oxides, methyl thio phenyl morpholino ketones and morpholino phenyl amino ketones; hydrogen abstracting photo radical polymerization initiators, which include a photo radical polymerization initiator and a coinitiator, based on benzophenones, thioxanthones, benzyls, camphorquinones, and ketocoumarins; and combinations thereof.

Preferred photo radical polymerization initiators include acylphosphine oxides including, e.g., bis(2,4,6-trimethylbenzoyl)-phenylphosphine oxide, bis(2,6-dimethoxybenzoyl)-(2,4,4-trimethylpentyl)phosphine oxide, and 2,4,4-trimethylbenzoyl diphenylphosphine oxide.

These photo radical polymerization initiators may be used alone or two or more of them may be used in combinations.

Useful commercially available photo radical polymerization initiators are available under the following trade designations IRGACURE 369 morpholino phenyl amino ketone, IRGACURE 819 bis(2,4,6-trimethylbenzoyl)-phenylphosphine oxide and its preferred form CGI819XF, IRGACURE CGI 403 bis(2, 6-dimethoxybenzoyl)-(2,4,4-trimethylpentyl) phosphine oxide, IRGACURE 651 benzyl dimethyl ketal, IRGACURE 184 benzoyl cyclohexanol, DAROCUR 1173 hydroxy alkyl phenyl ketones, DAROCUR 4265 50:50 blend of 2-hydroxy-2-methyl-1-phenylpropan-1-one and 2,4,6-trimethylbenzoyldiphenylphosphine oxide, and CGI1700 25:75 blend of bis(2,6-dimethoxybenzoyl)-2,4,4-trimethylpentylphosphine and 2-hydroxy-2-methyl-1-phenylpropan-1-one, all of which are available from Ciba-Geigy Corp (Ardsley, N.Y.).

In general, when photo radical polymerization initiator is present in the compositions, these compositions will be cured at room temperature within a length of time of less than 30 seconds, preferably less than 10 seconds, more preferably less than 5 seconds at wavelength in a range from 200 nm to 650 nm, preferably from 300 to 500 nm, followed by a heating curing process described herein. As will be understood, the time and wavelength curing profile for each curable adhesive composition will vary, and different compositions can be designed to provide the curing profile that will be suited to the particular industrial manufacturing process.

With particular preference, the component (D) if present, can be in an amount of 0 to 5%, preferably 1 to 3%, by weight of the total composition.

### Acrylic Resin

According to the present invention, the composition optionally comprises at least one acrylic resin selected from an acrylic acid ester monomer, a methacrylic acid ester monomer, or an oligomer thereof.

Examples of the acrylic acid ester monomer and/or the methacrylic acid ester monomer, or the oligomer thereof which are usable in the present invention may include diacrylate and/or dimethacrylate of tris(2-hydroxyethyl)isocyanurate, tris(2-hydroxyethyl)isocyanurate triacrylate and/or trimethacrylate, trimethylolpropane triacrylate and/or trimethacrylate, or an oligomer thereof, pentaerythritol triacrylate and/or trimethacrylate, or an oligomer thereof, polyacrylate and/or polymethacrylate of dipentaerythritol, tris(acryloxyethyl)isocyanurate, caprolactone modified tris(acryloxyethyl)isocyanurate, caprolactone modified tris(methacryloxyethyl)isocyanurate, polyacrylate and/or polymethacrylate of alkyl-modified dipentaerythritol, and polyacrylate and/or polymethacrylate of caprolactone modified dipentaerythritol.

Examples of a commercially available product of the acrylic resin may include polyester acrylate (product name: EBECRYL81O) manufactured by Daicel-Allnex Ltd., polyester acrylate (product name: M7100) manufactured by Toagosei Co., Ltd, tricyclodecane dimethanol diacrylate (product name: SR 833S) manufactured by Sartomer, and diacrylate ester of bisphenol A epoxy resin (product name: Ebecryl 3700) manufactured by Allnex.

These above-described acrylic resin may be used alone. Also, two or more components may be used in combination.

In preferred embodiments, the ratio of maleimide equivalents in the compound (A) and —C═C— carbon bond equivalents in the compound (E) to the mercapto equivalents in compound (B) is from 0.2 to 1.8, preferable from 1.0 to 1.5.

With particular preference, the curable adhesive composition does not contain any acrylic resin. If present, the component (E) may be incorporated into the curable adhesive composition in an amount of from 0% to 35% by weight, preferably from 15 to 25% by weight, based on the total weight of the composition.

### Additive

As necessary, the curable adhesive composition can be, without impairing the objective of the present invention, mixed with a filler such as a silica filler, a stabilizing agent, carbon black, titanium black, a silane coupling agent, an ion trapping agent, a leveling agent, an antioxidant, an antifoaming agent, a thixotropic agent, and other additives, for example. Moreover, the adhesive may be mixed with a viscosity adjustment agent, a flame retardant, or a solvent.

The additives can be in a variety of forms including, e.g., particles (spherical particles, beads, and elongated particles), fibers, and combinations thereof.

One useful class of stabilizers includes carbodiimide stabilizers.

Examples of useful antioxidants include hindered phenolic antioxidants, phosphite antioxidants, thioether antioxidants. Commercially available examples include RGANOX 565, 1010 and 1076 available from Ciba-Geigy (Hawthorne, N.Y.). The moisture curable polyurethane hot melt adhesive composition optionally includes no greater than about 2% by weight antioxidant.

Examples of useful pigments include inorganic, organic, reactive, and nonreactive pigments, and combinations thereof, which may be selected from metal oxide pigments, titanium dioxide, optionally surface-treated, zirconium oxide or cerium oxide, zinc oxide, iron oxide (black, yellow or red), chromium oxide, manganese.

According to the present invention, the additive may be present in an amount of from 0 to 10%, preferably from 2% to 6% by weight, based on the total weight of the composition.

### Composition and Cured Product

Preferred in accordance with the invention is the curable adhesive composition comprising:
from 10% to 80% by weight, preferably from 20% to 70% by weight of at least one maleimide compound;
from 15% to 70% by weight, preferably from 15 to 40% by weight of at least one thiol compound having at least two mercapto groups and no siloxane group in the molecule;
from 5% to 20% by weight, preferably from 5% to 15% by weight of at least one latent curing agent;
from 0 to 5% by weight, preferably from 1 to 3% by weight of at least one photo radical polymerization initiator; and
from 0 to 10% by weight, preferably from 2% to 6% by weight of at least one additive;
   wherein the weight percentages are based on the total weight of the composition.

### Manufacturing Method of Curable Adhesive Composition

The curable adhesive composition according to the present invention can be manufactured at room temperature by mixing (A) at least one maleimide compound, (B) at least one thiol compound having at least two mercapto groups and no siloxane group in the molecule; (C) at least one latent curing agent; and optionally, (D) at least one photo radical polymerization initiator, (E) acrylic resin and other additives if present. The apparatuses for these mixing, stirring, dispersing, and the like are not particularly limited. There can be used an automated mortar, a Henschel mixer, a three-roll mill, a ball mill, a planetary mixer, a bead mill, and the like which are equipped with a stirrer and a heater. Also, an appropriate combination of these apparatuses may be used. The manufacturing method of the curable adhesive composition is not particularly limited, as long as a composition in which the above-described components are uniformly mixed can be obtained.

### Curing Profile

In another aspect of the present invention, a method for bonding two substrates is provided, including applying the curable adhesive composition of the present invention to at least one of the substrates.

The curable adhesive composition can be applied to a substrate using any suitable application method including, e.g., automatic fine line dispensing, jet dispensing, slot die coating, roll coating, gravure coating, transfer coating, pattern coating, screen printing, spray coating, filament coating, by extrusion, air knife, trailing blade, brushing, dipping, doctor blade, offset gravure coating, rotogravure coating, and combinations thereof. The curable adhesive composition can be applied as a continuous or discontinuous coating, in a single or multiple layers and combinations thereof.

Optionally, the surface of the substrate on which the curable adhesive composition is applied is treated to enhance adhesion using any suitable method for enhancing adhesion to the substrate surface including, e.g., corona treatments, chemical treatments (e.g., chemical etching), flame treatments, abrasion, and combinations thereof.

According to the present invention, the curable adhesive composition of the present invention can be cured at temperature of lower than 100° C., preferably is from 60° C. to 80° C.

In preferred embodiments, when the photo radical polymerization initiator is present in the curable adhesive composition, the curing process may be initiated by UV radiation at room temperature within a length of time of less than 30 seconds, preferably less than 10 seconds, more preferably less than 5 seconds at wavelength in a range from 200 nm to 650 nm, preferably from 300 nm to 500 nm; and then followed by a heating curing process at temperature of lower than 100° C., preferably is from 60° C. to 80° C. for from 20 mins to 3 hours, preferably from 30 mins to 1.5 hours. As will be understood, the time and temperature curing profile for each adhesive composition will vary, and different compositions can be designed to provide the curing profile that will be suited to the particular industrial manufacturing process.

In some embodiments, the cured product of the curable adhesive composition exhibits an aspect ratio of no less than 0%, preferably no less than 20%, and more preferably no less than 40% after hydrothermal aging under a condition of 85° C. with the humidity of 85% for no less than 120 hours.

### Article, Electronic Device and the Use Thereof

In another aspect of the present invention, provided is an article comprising a first substrate, a cured adhesive, and a second substrate bonded to the first substrate through the cured adhesive derived from the curable adhesive composition according to the present invention.

The first substrate and/or second substrate can be of a single material and a single layer or can include multiple layers of the same or different material. The layers can be continuous or discontinuous.

The substrates of the article descried herein can have a variety of properties including rigidity (e.g., rigid substrates i.e., the substrate cannot be bent by an individual using two hands or will break if an attempt is made to bend the substrate with two hands), flexibility (e.g., flexible substrates i.e., the substrate can be bent using no greater than the force of two hands), porosity, conductivity, lack of conductivity, and combinations thereof.

The substrates of the article can be in a variety of forms including, e.g., fibers, threads, yarns, wovens, nonwovens, films (e.g., polymer film, metallized polymer film, continuous films, discontinuous films, and combinations thereof), foils (e.g., metal foil), sheets (e.g., metal sheet, polymer sheet, continuous sheets, discontinuous sheets, and combinations thereof), and combinations thereof.

Useful substrate material used in the present invention include, e.g., polymer (e.g., polycarbonate, ABS resin (Acrylonitrile-Butadiene-Styrene resin), liquid crystal polymer, polyolefin (e.g., polypropylene, polyethylene, low density polyethylene, linear low density polyethylene, high density polyethylene, polypropylene, and oriented polypropylene, copolymers of polyolefins and other comonomers), polyether terephthalate, ethylene-vinyl acetate, ethylene-methacrylic acid ionomers, ethylene-vinyl-alcohols, polyesters, e.g. polyethylene terephthalate, polycarbonates, polyamides, e.g. Nylon-6 and Nylon-6,6, polyvinyl chloride, polyvinylidene chloride, cellulosics, polystyrene, and epoxy), polymer composites (e.g., composites of a polymer and metal, cellulose, glass, polymer, and combinations thereof), metal (aluminum, copper, zinc, lead, gold, silver, platinum, and magnesium, and metal alloys such as steel (e.g., stainless steel), tin, brass, and magnesium and aluminum alloys), carbon-fiber composite, other fiber-based composite, graphene, fillers, glass (e.g., alkali-aluminosilicate toughened glass and borosilicate glass), quartz, boron nitride, gallium nitride, sapphire, silicon, carbide, ceramic, and combinations thereof, preferably liquid crystal polymer, glass and combinations thereof.

In an additional aspect of the invention, provided is an electronic device comprising the article of the present invention or produced using the curable adhesive composition according to the present invention.

Exemplary electronic devices encompass computers and computer equipment, such as printers, fax machines, scanners, keyboards and the like; medical sensors; automotive sensors and the like; wearable electronic devices (e.g., wrist watches and eyeglasses), handheld electronic devices (e.g., phones (e.g., cellular telephones and cellular smartphones), cameras, tablets, electronic readers, monitors (e.g., monitors used in hospitals, and by healthcare workers, athletes and individuals), watches, calculators, mice, touch pads, and joy sticks), computers (e.g., desk top and lap top computers), computer monitors, televisions, media players, household appliances (e.g., refrigerators, washing machines, dryers, ovens, and microwaves), light bulbs (e.g., incandescent, light emitting diode, and fluorescent), and articles that include a visible transparent or transparent component, glass housing structures, protective transparent coverings for a display or other optical component.

In yet another aspect of the invention, the use of the curable adhesive composition and the article according to this invention in manufacturing electronic devices is provided.

### EXAMPLES

The following examples are intended to assist one skilled in the art to better understand and practice the present invention. The scope of the invention is not limited by the examples but is defined in the appended claims. All parts and percentages are based on weight unless otherwise stated.

### Raw Materials:

SR 833S is tricyclodecane dimethanol diacrylate, available from Sartomer.

Ebecryl 3700 is the diacrylate ester of bisphenol A epoxy resin bisphenol, available from Allnex.

CM1016 is maleimide compound having formula structure (A1) described herein, available from Henkel.

SR525 is a phenylenedimaleimide having formula structure (A4) described herein, available from Sartomer.

BMI4 is the maleimide compound having formula structure (A3) described above, available from Henkel.

TrisMI-1 is the maleimide compound having formula structure (A5) described above, available from Henkel.

SMS-042 is a (mercaptopropyl)methylsiloxane dimethylsiloxane copolymer, available from Gelest.

KARENZ^{MT} BD1 is a thiol compound having the following chemical structure, available from Showa Corporation.

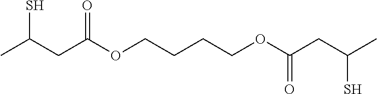 [SMILES: CC(S)CC(=O)OCCCCOC(=O)CC(C)S]

KARENZ^{MT} NR1 is a thiol compound having the formula structure (B12) described above, available from Showa Corporation.

Multhiol Y4 is a thiol compound having the formula structure (B8) described above, available from SC organic chemical.

C3TS-G is a thiol compound having the formula structure (B15) described above, available from Shikoku.

EH-5057P is a latent curing agent, available from ADEKA corporation.

HX-3722 is a latent curing agent, available from AsahiKASHI.

Speedcure TPO-L is a photo radical generator, available from IGM Resin.

TS 720 is a fumed silica, available from Cabot Corporation.

12S is a pigment, available from Mitsubishi Materials Corporation.

### Preparation Method:

### Example 1 (Ex.1)

3 g Speedcure TPO-L and 0.4 g 12S was mixed with 57.01 g BMI4 in a container covered with a lid. The mixture was stirred in Speedmixer DAC 150.1 FVZ-K (manufactured by FlackTek, Inc.) under the speed of 2000 rpm for 10 minutes at room temperature. Then 27.67 g KARENZ^{MT} NR1 was added in the container and the mixture was mixed under the speed of 1000 rpm for 5 minutes. Afterwards, 5.00 g EH-5057P and 4.30 g HX-3722 were added and mixed at 1000 rpm for 5 minutes, followed by adding 2.62 g TS 720 and mixed at 1000 rpm for another 5 minutes. Lastly, Thinky ARV-310 mixer was used to remove bubbles from homogeneous mixture to get the curable adhesive composition. The equivalent ratio of maleimide groups to mercapto groups is 1.26:1.00.

### Example 2 (Ex.2)

29.25 g Ebecryl 3700 and 24.44 g BMI4 was mixed in a container covered with a lid, and then 3 g Speedcure TPO-L and 0.4 g 12S was added. The mixture was stirred in Speedmixer DAC 150.1 FVZ-K (manufactured by FlackTek, Inc.) under the speed of 2000 rpm for 10 minutes at room temperature. Then 31.96 g KARENZ^{MT} NR1 was added in the container and the mixture was mixed under the speed of 1000 rpm for 5 minutes. Afterwards, 5.00 g EH-5057P and 3.91 g HX-3722 were added and mixed at 1000 rpm for 5 minutes, followed by adding 2.04 g TS 720 and mixed at 1000 rpm for another 5 minutes. Lastly, Thinky ARV-310 mixer was used to remove bubbles from homogeneous mixture to get the curable adhesive composition. The equivalent ratio of maleimide groups and —C═C— carbon bond to mercapto groups is 1.17:1.00.

### Example 3 (Ex.3)

44.70 g BMI4 and 12.28 CM1016 was mixed in a container covered with a lid, and then 3 g Speedcure TPO-L and 0.4 g 12S was added. The mixture was stirred in Speedmixer DAC 150.1 FVZ-K (manufactured by FlackTek, Inc.) under the speed of 2000 rpm for 10 minutes at room temperature. Then 29.33 g KARENZ^{MT} NR1 was added in the container and the mixture was mixed under the speed of 1000 rpm for 5 minutes. Afterwards, 4.00 g EH-5057P and 2.99 g HX-3722 were added and mixed at 1000 rpm for 5 minutes, followed by adding 3.30 g TS 720 and mixed at 1000 rpm for another 5 minutes. Lastly, Thinky ARV-310 mixer was used to remove bubbles from homogeneous mixture to get the curable adhesive composition. The equivalent ratio of maleimide groups to mercapto groups is 1.20:1.00.

### Example 4 (Ex.4)

44.94 g BMI4 and 10.55 TrisMI-1 was mixed in a container covered with a lid, and 3 g Speedcure TPO-L and 0.4 g 12S was added. The mixture was stirred in Speedmixer DAC 150.1 FVZ-K (manufactured by FlackTek, Inc.) under the speed of 2000 rpm for 10 minutes at room temperature. Then 29.51 g KARENZ^{MT} NR1 was added in the container and the mixture was mixed under the speed of 1000 rpm for 5 minutes. Afterwards, 4.00 g EH-5057P and 3.39 g HX-3722 were added and mixed at 1000 rpm for 5 minutes, followed by adding 4.21 g TS 720 and mixed at 1000 rpm for another 5 minutes. Lastly, Thinky ARV-310 mixer was used to remove bubbles from homogeneous mixture to get the curable adhesive composition. The equivalent ratio of maleimide groups to mercapto groups is 1.20:1.00.

### Example 5 (Ex.5)

9.73 g SR 833S, 24.75 g Ebecryl 3700 and 28.01 g BMI4 was mixed in a container covered with a lid, and 0.4 g 12S was added. The mixture was stirred in Speedmixer DAC 150.1 FVZ-K (manufactured by FlackTek, Inc.) under the speed of 2000 rpm for 10 minutes at room temperature. Then 21.73 g C3TS-G was added in the container and the mixture was mixed under the speed of 1000 rpm for 5 minutes. Afterwards, 6.00 g EH-5057P and 4.93 g HX-3722 were added and mixed at 1000 rpm for 5 minutes, followed by adding 4.45 g TS 720 and mixing at 1000 rpm for another 5 minutes. Lastly, Thinky ARV-310 mixer was used to remove bubbles from homogeneous mixture to get the curable adhesive composition. The equivalent ratio of maleimide groups and —C═C— carbon bond to mercapto groups is 1.30:1.00.

### Example 6 (Ex.6)

69.73 g BMI4 was mixed with 0.4 g 12S in a container covered with a lid. The mixture was stirred in Speedmixer DAC 150.1 FVZ-K (manufactured by FlackTek, Inc.) under the speed of 2000 rpm for 10 minutes at room temperature. Then 19.71 g C3TS-G was added in the container and the mixture was mixed under the speed of 1000 rpm for 5 minutes. Afterwards, 4.00 g EH-5057P and 3.00 g HX-3722 were added and mixed at 1000 rpm for 5 minutes, followed by adding 3.16 g TS 720 and mixing at 1000 rpm for another 5 minutes. Lastly, Thinky ARV-310 mixer was used to remove bubbles from homogeneous mixture to get the curable adhesive composition. The equivalent ratio of maleimide groups to mercapto groups is 1.30:1.00.

### Example 7 (Ex.7)

65.86 g BMI4 was mixed with 0.4 g 12S in a container covered with a lid. The mixture was stirred in Speedmixer DAC 150.1 FVZ-K (manufactured by FlackTek, Inc.) under the speed of 2000 rpm for 10 minutes at room temperature. Then 20.23 g Multhiol Y4 was added in the container and the mixture was mixed under the speed of 1000 rpm for 5 minutes. Afterwards, 5.00 g EH-5057P and 3.36 g HX-3722 were added and mixed at 1000 rpm for 5 minutes, followed by adding 5.15 g TS 720 and mixing at 1000 rpm for another 5 minutes. Lastly, Thinky ARV-310 mixer was used to remove bubbles from homogeneous mixture to get the curable adhesive composition. The equivalent ratio of maleimide groups to mercapto groups is 1.30:1.00.

### Example 8 (Ex.8)

4.02 g SR525 and 57.22 g BMI4 was mixed in a container covered with a lid, and 0.4 g 12S was added. The mixture was stirred in Speedmixer DAC 150.1 FVZ-K (manufactured by FlackTek, Inc.) under the speed of 2000 rpm for 10 minutes at room temperature. Then 27.82 g KARENZ^{MT} NR1 was added in the container and the mixture was mixed under the speed of 1000 rpm for 5 minutes. Afterwards, 9.07 g EH-5057P was added and mixed at 1000 rpm for 5 minutes, followed by adding 1.47 g TS 720 and mixing at 1000 rpm for another 5 minutes. Lastly, Thinky ARV-310 mixer was used to remove bubbles from homogeneous mixture to get the curable adhesive composition of the present invention. The equivalent ratio of maleimide groups to mercapto groups is 1.50:1.00.

### Example 9 (Ex.9)

60.86 g TrisMI-1 was mixed with 0.4 g 12S in a container covered with a lid. The mixture was stirred in Speedmixer DAC 150.1 FVZ-K (manufactured by FlackTek, Inc.) under the speed of 2000 rpm for 10 minutes at room temperature. Then 24.99 g KARENZ^{MT} BD1 was added in the container and the mixture was mixed under the speed of 1000 rpm for 5 minutes. Afterwards, 5.00 g EH-5057P and 5.00 g HX-3722 were added and mixed at 1000 rpm for 5 minutes, followed by adding 3.75 g TS 720 and mixing at 1000 rpm for another 5 minutes. Lastly, Thinky ARV-310 mixer was used to remove bubbles from homogeneous mixture to get the curable adhesive composition of the present invention. The equivalent ratio of maleimide groups to mercapto groups is 1.22:1.00.

### Comparative Example 1 (CE.1)

37.54 g SR 833S and 0.4 g 12S was added in the container covered with a lid. The mixture was stirred in Speedmixer DAC 150.1 FVZ-K (manufactured by FlackTek, Inc.) under the speed of 2000 rpm for 10 minutes at room temperature. Then 35.72 g KARENZ^{MT} NR1 was added in the container and the mixture was mixed under the speed of 1000 rpm for 5 minutes. Afterwards, 10.00 g EH-5057P and 6.90 g HX-3722 were added and mixed at 1000 rpm for 5 minutes, followed by adding 6.44 g TS 720 and mixing at 1000 rpm for another 5 minutes. Lastly, Thinky ARV-310 mixer was used to remove bubbles from homogeneous mixture to get the curable adhesive composition.

### Comparative Example 2 (CE.2)

52.65 g Ebecryl 3700 and 0.4 g 12S was added in the container covered with a lid. The mixture was stirred in Speedmixer DAC 150.1 FVZ-K (manufactured by FlackTek, Inc.) under the speed of 2000 rpm for 10 minutes at room temperature. Then 33.84 g KARENZ^{MT} NR1 was added in the container and the mixture was mixed under the speed of 1000 rpm for 5 minutes. Afterwards, 5.00 g EH-5057P and 3.91 g HX-3722 were added and mixed at 1000 rpm for 5 minutes, followed by adding 1.20 g TS 720 and mixing at 1000 rpm for another 5 minutes. Lastly, Thinky ARV-310 mixer was used to remove bubbles from homogeneous mixture to get the curable adhesive composition.

### Comparative Example 3 (CE.3)

19.46 g SR 833S, 39.50 g Ebecryl 3700 and 0.4 g 12S was added in the container covered with a lid. The mixture was stirred in Speedmixer DAC 150.1 FVZ-K (manufactured by FlackTek, Inc.) under the speed of 2000 rpm for 10 minutes at room temperature. Then 26.18 g Multhiol Y4 was added in the container and the mixture was mixed under the speed of 1000 rpm for 5 minutes. Afterwards, 7.00 g EH-5057P and 3.30 g HX-3722 were added and mixed at 1000 rpm for 5 minutes, followed by adding 4.16 g TS 720 and mixing at 1000 rpm for another 5 minutes. Lastly, Thinky ARV-310 mixer was used to remove bubbles from homogeneous mixture to get the curable adhesive composition.

### Comparative Example 4 (CE.4)

46.46 g BMI4 was mixed with 0.4 g 12S in a container covered with a lid. The mixture was stirred in Speedmixer DAC 150.1 FVZ-K (manufactured by FlackTek, Inc.) under the speed of 2000 rpm for 10 minutes at room temperature. Then 42.22 g SMS-042 was added in the container and the mixture was mixed under the speed of 1000 rpm for 5 minutes. Afterwards, 5.00 g EH-5057P and 3.50 g HX-3722 were added and mixed at 1000 rpm for 5 minutes, followed by adding 2.42 g TS 720 and mixed at 1000 rpm for another 5 minutes. Lastly, Thinky ARV-310 mixer was used to remove bubbles to get the curable adhesive composition. However, phase separation of the adhesive composition mixture was observed soon after the preparation.

### Comparative Example 5 (CE.5)

35.98 g BMI4 was mixed with 11.98 g TrisMI-1 in a container covered with a lid, and then 0.4 g 12S was added. The mixture was stirred in Speedmixer DAC 150.1 FVZ-K (manufactured by FlackTek, Inc.) under the speed of 2000 rpm for 10 minutes at room temperature. Then 44.21 g SMS-042 was added in the container and the mixture was mixed under the speed of 1000 rpm for 5 minutes. Afterwards, 6.30 g HX-3722 were added and mixed at 1000 rpm for 5 minutes, followed by adding 1.13 g TS 720 and mixed at 1000 rpm for another 5 minutes. Lastly, Thinky ARV-310 mixer was used to remove bubbles to get the curable adhesive composition. However, phase separation of the adhesive composition mixture was observed soon after the preparation.

### Test Methods:

### Die Shear Strength of Adhesion to LCP Substrate Before Hydrothermal Aging:

From Ex. 1 to Ex. 4 and CE. 1 and CE. 2, the composition was coated onto a glass upper-adherend 3*3 mm² square with the thickness of 0.8 mm. Then placed the glass upper adherend onto the LCP substrate. Ten laminated samples were prepared for each composition. All laminated sample of each composition were cured under UV radiation for 2 s at wavelength of 365 nm and then followed by thermal cure at an oven for 1 hour at 70° C. No pressure was used. After curing, five of the ten laminated samples of each composition's Die Shear Strength was measured using DAGE4000 (manufactured from Nordson Corporation) at 25° C. Afterwards, the five testing values were averaged as the final die shear strength.

From Ex. 5 to Ex. 9 and CE. 3 to CE. 5, the composition was coated onto a 5×5 mm² LCP (Liquid Crystal Polymer) substrate with the thickness of 2 mm. Then another LCP substrate was fully covered the curable adhesive layer. Ten laminated samples were prepared for each composition. All laminated samples were thermally cured at an oven for 1 hour at 70° C. No pressure was used. After curing, five of the ten laminated samples of each composition's Die Shear Strength was measured using DAGE4000 (manufactured from Nordson Corporation) at 25° C. Afterwards the five testing values were averaged as the final die shear strength.

### Hydrothermal Aging Test:

After curing, another five laminated samples of each composition were put in Temperature & Humidity chamber SH-642 Bench-top (manufactured by ESPEC) at 85° C. with the humidity of 85% for 120 hours.

Die Shear Strength of Adhesion to LCP Substrate after Hydrothermal Aging:

After hydrothermal aging, each sample's Die Shear Strength was measured using DAGE4000 (manufactured from Nordson Corporation) at 25° C. Afterwards, the five testing values were averaged as the final die shear strength.

### Retention Rate was Calculated According to the Following Equation:

Retention rate=(die shear strength after hydrothermal aging−die shear strength before hydrothermal aging)/die shear strength before hydrothermal aging)*100%.

From Ex. 1 to Ex. 4 and CE. 1 and CE.2, a retention rate of no less than 0 is acceptable; from Ex. 5 to Ex. 9 and CE. 3 to CE. 5, a retention rate of no less than 0 is acceptable, preferably greater than 40%, more preferably greater than 70%, meaning that the adhesive composition can endure hydrothermal environment.

The test results of the performance evaluation on the inventive and comparative curable adhesive composition are shown in Tables 1 and 2, respectively.

TABLE 1
Test results of Ex. 1 to Ex. 4 and CE. 1 and CE.2

| Test Item | CE. 1 | CE. 2 | EX. 1 | EX. 2 | EX. 3 | EX. 4 |
|---|---|---|---|---|---|---|
| Die shear strength | 6.0 | 12.1 | 16.6 | 12.3 | 11.7 | 16.6 |
| before hydrothermal | | | | | | |
| aging (UV and heat, | | | | | | |
| Glass/LCP), Kg | | | | | | |
| Die shear strength | 2.1 | 10.7 | 16.9 | 13.8 | 11.9 | 16.6 |
| after hydrothermal | | | | | | |
| aging (UV and heat, | | | | | | |
| Glass/LCP), Kg | | | | | | |
| Retention Rate | −65.00% | −11.57% | 1.81% | 12.20% | 1.71% | 0.00% |

The results in Table 1 showed that the curable adhesive composition comprising a combination of the maleimide compound and the thiol compound exhibited excellent hydrothermal resistant property, while without the maleimide compound, the curable adhesive composition cannot endure hydrothermal test.

TABLE 2
Test results of Ex. 5 to Ex. 9 and CE. 3 to CE. 5

| Test Item | CE. 3 | EX. 5 | EX. 6 | EX. 7 | EX. 8 | EX. 9 |
|---|---|---|---|---|---|---|
| Die shear strength | 10.8 | 26.6 | 30.0 | 10.9 | 26.4 | 24.9 |
| before hydrothermal | | | | | | |
| aging (only heat, | | | | | | |
| LCP/LCP), Kg | | | | | | |
| Die shear strength | 8.8 | 34.1 | 43.4 | 26.5 | 45.2 | 25.0 |
| after hydrothermal | | | | | | |
| aging (only heat, | | | | | | |
| LCP/LCP), Kg | | | | | | |
| Retention Rate | −18.51% | 28.20% | 44.67% | 143.12% | 71.21% | 0.40% |

The components in CE.4 and CE.5 cannot form homogeneous adhesive compositions to be applied on the substrates, and therefore die shear strength cannot be measured.

The results in Table 2 showed that the thermal curable adhesive compositions comprising a combination of maleimide compound (A) and the thiol compound (B) according to the present invention exhibited excellent hydrothermal resistant property, while without the maleimide compound, the thermal curable adhesive composition cannot endure hydrothermal test.

Although some preferred embodiments have been described, many modifications and variations may be made thereto in light of the above teachings. It is therefore to be understood that the invention may be practiced otherwise than as specifically described without departing from the scope of the appended claims.

What is claimed is:

1. A curable adhesive composition comprising:
(A) at least one maleimide compound;
(B) at least one thiol compound having at least two mercapto groups and no siloxane group in the molecule;
(C) at least one latent curing agent; and
(D) optionally, at least one photo radical polymerization initiator.

2. The composition according to claim 1, wherein the maleimide compound has generic formula structure (I): 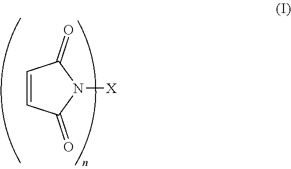
wherein n is an integer no less than 2, X is an aromatic group or aliphatic group.

3. The composition according to claim 1, wherein the maleimide compound is bismaleimide having the formula structure (II): 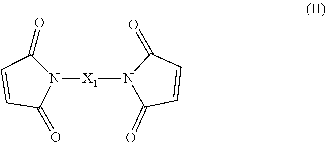
wherein X₁ is a selected from linear or branched alkylenes, cycloalkylenes, bicycloalkylenes, tricycloalkylenes, alkenylenes, arylenes, aralkylenes, arylbicycloalkylenes, aryltricycloalkylenes, cycloalkenylene, cycloalkylarylenes, biphenylenes, heterocycloalkylene or heterocycloarylenes having from 1 to 36 carbon atoms and optionally contain at least one carbonyl group, carboxyl group, amide group, carbamate group, urea group, ester group, ether group, and combinations thereof.

4. The composition according to claim 1, wherein the at least one thiol compound comprises at least three mercapto groups.

5. The composition according to claim 1, wherein the at least one thiol compound comprises at least two mercapto groups bonded to a divalent linking unit selected from C₁-C₃₆ aliphatic groups, C₄-C₃₆ alicyclic groups, C₆-C₄₀ aromatic groups, urethane groups, imide groups, carbonyl groups, carboxyl groups, amide groups, carbamate groups, urea groups, ester groups, ether groups, poly(butadiene) groups, polycarbonate groups, polyurethane groups, polyether groups, polyester groups and combinations thereof.

6. The composition according to claim 5, wherein the divalent linking unit is C₁₂-C₃₆ aliphatic groups containing one or more ether groups.

7. The composition according to claim 6, wherein the thiol compound is selected from 3,3′-[[2,2-bis[(3-mercaptopropoxy)methyl]propane-1,3-diyl]dioxy]bis(propane-1-thiol), 1-[3-(2-sulfanylpropoxy)-2,2-bis(2-sulfanylpropoxymethyl)propoxy]propane-2-thiol, 3-[2-(methoxymethyl)-3-(3-sulfanylpropoxy)-2-(3-sulfanylpropoxymethyl)propoxy]propane-1-thiol, 2-(sulfanylmethyl)-2-[[3-sulfanyl-2-[[3-sulfanyl-2,2-bis(sulfanylmethyl)propoxy]methyl]-2-(sulfanylmethyl)propoxy]methyl]propane-1,3-dithiol, 2-[3-(2-sulfanylethoxy)-2,2-bis(2-sulfanylethoxymethyl)propoxy]ethanethiol, 2-[2-[3-[2-(2-sulfanylethoxy)ethoxy]-2,2-bis[2-(2-sulfanylethoxy)ethoxymethyl]propoxy]ethoxy]ethanethiol, 3-[2-(butoxymethyl)-3-(3-sulfanylpropoxy)-2-(3-sulfanylpropoxymethyl)propoxy]propane-1-thiol, 3-[2-[2-(2-sulfanylethoxy)ethoxymethyl]-2-(2-sulfanylethylperoxymethyl)-3-(3-sulfanylpropoxy)propoxy]propane-1-thiol, 3-[2-(2-sulfanylethylperoxymethyl)-3-(3-sulfanylpropoxy)-2-(3-sulfanylpropoxymethyl)propoxy]propane-1-thiol, 3-[3-(3-sulfanylpropoxy)-2-[[3-(3-sulfanylpropoxy)-2,2-bis(3-sulfanylpropoxymethyl)propoxy]methyl]-2-(3-sulfanylpropoxymethyl)propoxy]propane-1-thiol, 2-[3-(2-sulfanylethoxy)-2-[[3-(2-sulfanylethoxy)-2,2-bis(2-sulfanylethoxymethyl)propoxy]methyl]-2-(2-sulfanylethoxymethyl)propoxy]ethanethiol, 3-[2,2-bis[2-(2-sulfanylethoxy)ethoxymethyl]-3-(2-sulfanylethylperoxy)propoxy]propane-1-thiol, 3-[2-[3-[2-(3-sulfanylpropoxy)ethoxy]-2,2-bis[2-(3-sulfanylpropoxy)ethoxymethyl]propoxy]ethoxy]propane-1-thiol, O-[3-(3-sulfanylpropanethioyloxy)-2-[[3-(3-sulfanylpropanethioyloxy)-2,2-bis(3-sulfanylpropanethioyloxymethyl)propoxy]methyl]-2-(3-sulfanylpropanethioyloxymethyl)propyl]3-sulfanylpropanethioate and combinations thereof.

8. The composition according to claim 5, wherein the divalent linking unit is C₄-C₃₆ alicyclic groups or C₆-C₄₀ aromatic groups selected from C₄-C₃₆ cycloalkylenes, bicycloalkylenes, tricycloalkylenes, alkenylenes, arylenes, aralkylenes, arylbicycloalkylenes, aryltricycloalkylenes, cycloalkenylene, cycloalkylarylenes, biphenylenes, heterocycloalkylene, heterocycloarylenes and combinations thereof.

9. The composition according claim 8, wherein the thiol compound is selected from 1,3,4,6-tetra(2-mercaptoethyl)octahydroimidazo[4,5-d]imidazole-2,5-dione, 1,3,4,6-tetrakis(3-sulfanylpropyl)-3a,6a-dihydroimidazo[4,5-d]imidazole-2,5-dione, 3a-methyl-1,3,4,6-tetrakis(2-sulfanylethyl)-6aH-imidazo[4,5-d]imidazole-2,5-dione, 1,3,4,6-tetrakis(2-methylsulfanylethyl)-3a,6a-dihydroimidazo[4,5-d]imidazole-2,5-dione, 1,6-dipropyl-3,4-bis(2-sulfanylethyl)-3a,6a-dihydroimidazo[4,5-d]imidazole-2,5-dione, 6-propyl-1,3,4-tris(2-sulfanylethyl)-3a,6a-dihydro-2H-imidazo[4,5-d]imidazol-5-one, and combinations thereof.

10. The composition according to claim 1, wherein the ratio of maleimide equivalents in the component (A) to the mercapto equivalents in component (B) is from 0.2 to 1.8.

11. The composition according to claim 1, wherein the latent curing agent is selected from an imidazole compound, amine adducts obtained by the reaction products of an amine compound with an epoxy compound, an isocyanate compound and/or a urea compound, core-shell type latent curing agent, master batch type latent curing agent, and combinations thereof.

12. The composition according to claim 1, wherein the photo radical polymerization initiator is selected from “alpha cleavage type” photo radical polymerization initiators including, benzyl dimethyl ketal, benzoin ethers, hydroxy alkyl phenyl ketones, benzoyl cyclohexanol, dialkoxy acetophenones, 1-hydroxycyclohexyl phenyl ketone, trimethylbenzoyl phosphine oxides, methyl thio phenyl morpholino ketones and morpholino phenyl amino ketones; hydrogen abstracting photo radical polymerization initiators including a photo radical polymerization initiator and a coinitiator, based on benzophenones, thioxanthones, benzyls, camphorquinones, ketocoumarins, and combinations thereof.

13. The composition according to claim 1, wherein the composition further comprises component (E) at least one acrylic resin selected from an acrylic acid ester monomer, a methacrylic acid ester monomer, or an oligomer thereof.

14. The composition according to claim 1, wherein the component (A) is present in an amount of from 10 to 80% by weight.

15. The composition according to claim 1, wherein the component (B) is present in an amount of from 15% to 70% by weight, based on the total weight of the composition.

16. The composition according to claim 1, wherein the component (C) in an amount of from 5 to 20% by weight, based on the total weight of the composition.

17. The composition according to claim 1 is present in an amount of from 0 to 5% by weight, based on the total weight of the composition.

18. The composition according to claim 1, wherein the component (E) is present in an amount of from 0 to 35% by weight, based on the total weight of the composition.

19. An article comprising:
a first substrate,
a cured adhesive, and
a second substrate bonded to the first substrate through the cured adhesive derived from the curable adhesive composition according to claim 1.

20. An electronic device comprising the article of claim 19.
